(19) United States
(12) Patent Application Publication
(10) Pub. No.: US 2008/0042470 A1
(43) Pub. Date: Feb. 21, 2008

(54) Cover for the Drive Housing of a Windscreen Wiper System

(76) Inventors: Claus Fleischer, Buehl (DE); Achim Hawighorst, Buehlertal (DE)

Correspondence Address: MICHAEL BEST & FRIEDRICH LLP, 100 EAST WISCONSIN AVENUE, MILWAUKEE, WI, 53202, US

(21) Appl. No.: 11/628,071

(22) PCT Filed: Apr. 28, 2005
(86) PCT No.: PCT/EP05/51939

§ 371 Date: Nov. 29, 2006

(30) Foreign Application Priority Data
Jun. 4, 2004 (DE) 10 2004 027 504.1

(51) Int. Cl. B60S 1/34

(52) U.S. Cl. 296/190.1

(57) ABSTRACT

The cover is comprised of a metallic base plate (2) and conductor tracks (18) that are embedded in plastic. The aim of the invention is simplifying the injection molding process. To achieve this, a plastic part (5) is provided with embedded conductor tracks (18), which part has a head region (6) that is configured as a plug and a flat expanded foot region (7), and which part is guided through an opening (14) that is configured in the base plate (2) from the underside of the cover in such a way that the flat areas of the foot region (7) engage behind the opening (14) and lie tightly against the underside of the cover.

### PRIOR ART

The invention relates to a cover for the gear housing of a windshield wiper system comprised of a metallic base plate and conductor tracks that are embedded in plastic, which are guided from a plug arranged on the outside of the cover through an opening provided in the base plate to the underside of the cover.

This type of gear housing used in drive assemblies for windshield wiper systems is already known from DE 195 48 823 A1.

The drive assembly is normally comprised of an electric motor, which drives a worm wheel gear. The gear is housed in a pot-shaped gear housing to which the electric motor is attached laterally. The worm wheel is located in the gear housing, wherein the output axis leads to the outside through the base. The worm wheel is driven by a worm, which is embodied in the extension of the motor shaft. The power is supplied to the electric motor via a plug that is provided externally on the cover, from which conductor tracks are guided through an opening in the cover into the inside of the gear housing. Additional conductor tracks that can be connected via the plug can be provided for instance to make control signals, e.g., via a so-called parking position switch, available.

In the case of the gear cover known from DE 195 48 823 A1, the conductor tracks are embedded in a plastic layer, which is sprayed on the metallic base plate, in particular on its outer side and which as a rule has a section that is embodied as a plug. The metallic base plate has openings whose edges are surrounded by the plastic layer, wherein the conductor tracks are guided through these openings to the underside of the cover. In order to design the known gear cover so that it is corrosion-proof and mechanically stable, it is necessary to provide the extended regions on the outer side, on the edge and on the underside of the basic plate with plastic surfaces.

Currently, gear covers that are manufactured without a metallic base plate, i.e., made completely of plastic, are used in many cases. Regardless of the fact that any interference radiation can radiate undesirably through these kinds of plastic gear covers, these types of plastic parts with a high degree of integration and customer-specific designs are very expensive, particularly in terms of the costs of the injection molding die. Even the locking hooks that are typically provided to fasten the plastic cover on the gear housing are relatively expensive to manufacture using injection molding (position, shape, temperature, etc.). Similar to the aforementioned large-surface extrusion coatings of a metallic base plate, fixing the conductor tracks (inlays) is especially problematic in injection molding, however. This requires expensive return traverse technology in particular. In order to avoid expensive extrusion coating of the conductor tracks, U.S. Pat. No. 5,864,188 proposed inserting the conductor tracks without extrusion coating between a surface of the plastic gear cover and an additional cover part to be fastened on the surface.

As a result, the object of the invention is embodying the cover in such a way that it combines good protection from corrosion with simple, particularly cost-effective, manufacturability.

This object is attained in accordance with the invention by a gear cover in accordance with claim 1. Advantageous embodiments are characterized in the subordinate claims.

For the gear cover in accordance with the invention with conductor tracks that are guided through an opening in a metallic base plate, a plastic part with embedded conductor tracks that has been manufactured separately in advance is provided, which part has a head region that is configured as a plug and a flat expanded foot region, and which part is guided through the matching opening from the underside of the cover in such a way that the flat areas of the foot region engage behind the opening and lie tightly against the underside of the cover. The relatively small and less complex plastic part can be manufactured simply and cheaply using injection molding so that the cover as a whole is cost-effective to manufacture.

It is advantageous in accordance with an embodiment of the invention, if the plastic part has a center region connecting the head region with the foot region as a one-part piece, which center region extends through the opening of the base plate and in which the conductor tracks are guided approximately perpendicular to the base plate. As a result, a simple, but diversely variable design is produced with a great play for the arrangement or configuration of the conductor tracks.

According to a first variation of this embodiment, it is advantageous in this case that adjacent to the center region, at least one of the conductor tracks is guided further, perpendicular to the base plate through the foot region of the plastic part, and, beneath the opening of the base plate, is guided out of the foot region of the plastic part.

It is possible, according to a second variation, which can also be combined with the first variation, that adjacent to the center region, at least one of the conductor tracks is guided further, parallel to the base plate in the foot region of the plastic part, and then, offset from the opening, is guided out of the foot region perpendicularly.

In general it is advantageous that the foot region of the plastic part has a region that is embodied to be plate-like, whose upper side thereby lies very tightly against the underside of the cover.

In this case, it is moreover advantageous that electrical components are provided on the underside of the plate-like region of the foot region of the plastic part, which electrical components have an electrical connection with one another and with at least one conductor track that is guided out of the foot region. In this connection, it is advantageous for a flat metal grid to be provided on the underside of the plate-like foot region for connecting the electrical components with one another and with the conductor tracks that are guided out.

In all variations means can also be provided for tightly fastening the plastic part on the base plate.

Exemplary embodiments of the invention are depicted in the drawings and explained in greater detail in the following description. The drawings show:

FIG. 1A lateral section through a gear housing with a gear cover mounted on it in accordance with the invention.

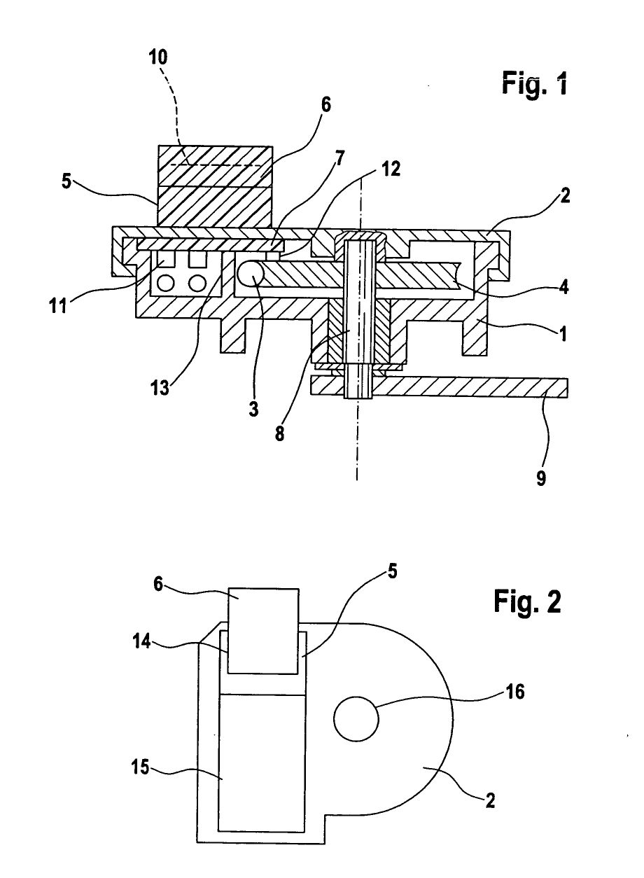

FIG. 2 A top view of the gear cover according to FIG. 1.

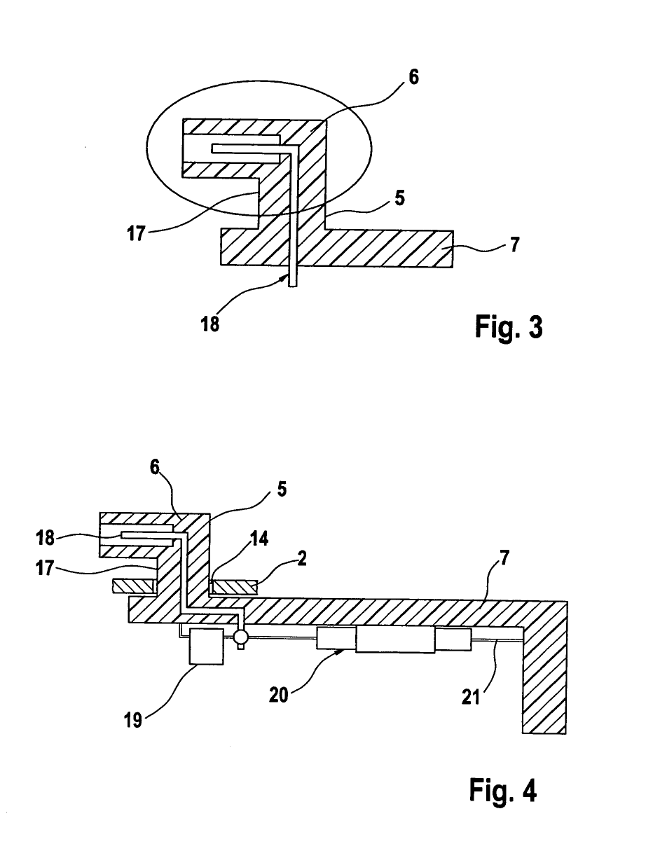

FIG. 3 A lateral section through a first exemplary embodiment for the plastic part provided on the gear cover in accordance with the invention.

FIG. 4 A second exemplary embodiment in the representation in accordance with FIG. 3.

FIG. 1 depicts a section of a gear housing, which is comprised of a housing pot 1 and a gear cover in accordance with the invention. Flanged laterally onto the housing pot 1 is a motor (not shown here), whose motor shaft 3 bears a worm on its end, and this worm drives the worm wheel 4 arranged in the gear housing. In accordance with the invention, the gear cover is comprised of a metallic base plate 2 and a pre-fabricated plastic part 5, whose head region 6 is configured as a plug and whose foot region 7 is a flat expanded region so that the foot region 7 can lie tightly against the underside of the base plate 2 in the depicted manner. A seal is required to obtain a closed, corrosion-proof gear housing. The worm wheel 4 is permanently connected to an output shaft 8, which is guided through the base of the housing pot 1. In many cases, the wiper gear includes a conversion gear (not shown in this case), which converts the rotational movement of the worm wheel 4 into a pendulum movement of the crank 9 that is connected to the wiper arm. The output shaft 8 can be supported on a bearing on the underside of the metallic base plate 2.

As FIG. 1 further shows, the plug 6 has five contacts 10 for example, which are connected to corresponding conductor tracks (see FIGS. 3 and 4), which are embedded in the plastic part 5 and extend up to the under side of the foot region 7, from which they project into the interior space of the gear housing. Depending upon the function, the housing-side ends of the conductor tracks can be embodied and arranged in a different manner. For example, plug contacts 11, which are indicated only schematically in FIG. 1 and are used to supply power to the flanged-on electric motor, and contact tags 12 can be provided, wherein the latter can form a parking position switch in cooperation with contact pads that are arranged concentrically on the upper side of the worm wheel 4. The fastening of the gear cover on the housing pot 1 can be realized in various ways, e.g., by the depicted clipping on or bending of the gear cover sheet metal 2 on the edge of the gear pot 1. Even the tight fastening of the plastic part 5 in the opening of the base plate 2 can be accomplished in different ways, for instance by a press fit or by locking means. If need be, the tight fastening can be assisted by supporting the foot region 7 on a rib 13 in the interior space of the gear housing, as depicted in FIG. 1. The design of the gear cover in accordance with the invention is not tied to the configuration depicted in FIG. 1. In particular, the worm wheel 4 can essentially occupy the entire inside diameter of the gear pot 1, or additional horizontal and/or vertical and, if need be, moveable structural components can be provided in the housing pot 1 for the parking position switch.

FIG. 2 shows, in a very schematic manner, a top view of the gear cover in accordance with the invention with the base plate 2, the opening 14 provided therein and the plastic part 5 with the head region 6 configured as a plug. The shape and size of the opening 14 allows the pre-fabricated plastic part 5 for completing the gear cover to be guided from the underside of the base plate, i.e., at least with its head region 6, through the base plate 2 so that afterwards the plug is situated on the outside of the gear cover. In addition, for the sake of illustration, FIG. 2 shows a variation region 15, which indicates the range of other positions of the opening 14 on the gear cover that are possible as alternatives. Depending upon the customer's desires, the plug can be arranged flexibly or spatially aligned in this way. The gear cover in accordance with the invention is comprised essentially of metal and consequently can be manufactured with regard to its outer contour as a cost-effective stamped part, which can, without hesitation, also be deep drawn, e.g., for a bearing 16 for the output shaft 8 shown in FIG. 1, or be embossed for higher strength. The opening 14 for the plug/plastic part 5 can be created by a die and, therefore, can be varied simply in terms of position and shape.

FIG. 3 shows the separate plastic part 5 that is not yet mounted in the base plate 2, which has a head region 6 configured as a plug and a flat expanded foot region 7, which are connected as a one-part piece via a center region 17 arranged approximately perpendicular to the base plate 2. In addition, a conductor track 18 is evident, whose housing-side end projects approximately perpendicularly from the underside of the foot region 7, while its other end is integrated into the plug or the head region 6. The foot region 7 can have a height of only a few millimeters so that no appreciable construction space is required in the interior space of the gear housing. The foot region 7 is embodied to be advantageously plate-like, as shown in FIG. 3, so that its upper side that engages behind the opening 14 can lie closely and tightly against the underside of the base plate 2.

FIG. 4 shows another embodiment of the plastic part 5, in which the foot region 7 has a greater lateral extension thereby opening up the possibility of arranging electrical components on its underside, e.g., a coil 19 and/or a brush holder 20 integrated into the gear housing. In addition, as a result, the conductor track 18 can be guided out of the foot region 7 offset from the position of the opening 14 in the base plate 2. Of course, modifications in which a portion of the conductor tracks 18 are guided out of the foot region 7 beneath the opening 14 of the base plate 2 indicated in FIG. 4 and another portion of the conductor tracks 18 are guided out of the foot region 7 in an offset manner are possible and realizable without hesitation. As for the rest, a punched grid 21, for example, can be provided on the underside of the foot region 7 in order to establish the electrical connection between the components 19 and 20 as well as the conductor track 18.

Common to all embodiments of the invention is the plastic part 5 that is small and less complex as compared with the gear cover or with previous plastic extrusion coatings or plastic covers. As a result, not just expensive brackets, locking hooks, etc., are dispensed with, but above all the conductor tracks 18 can be embedded into the plastic more easily since only relatively small-volume extrusion coating takes place, thereby eliminating expensive injection molding die reverse traverse technology in particular.

1. Cover for a gear housing of a windshield wiper system comprised of a metallic base plate (2) and conductor tracks (18) that are embedded in plastic, which are guided from a plug arranged on the outside of the cover through an opening (14) provided in the base plate (2) to the underside of the cover, characterized in that a plastic part (5) with embedded conductor tracks (18) is provided, which part has a head region (6) that is configured as a plug and a flat expanded foot region (7), and which part is guided through the matching opening (14) from the underside of the cover in such a way that the flat areas of the foot region (7) engage behind the opening (14) and lie tightly against the underside of the cover.

2. Cover according to claim 1, characterized in that the plastic part (5) has a center region (17) connecting the head region (6) with the foot region (7) as a one-part piece, which center region extends through the opening (14) of the base plate (2) and in which the conductor tracks (18) are guided approximately perpendicular to the base plate (2).

3. Cover according to claim 2, characterized in that adjacent to the center region (17), at least one of the conductor tracks (18) is guided further, perpendicular to the base plate (2) through the foot region (7) of the plastic part (5), and, beneath the opening (14) of the base plate (2), is guided out of the foot region (7) of the plastic part (5).

4. Cover according to claim 2, characterized in that adjacent to the center region (17), at least one of the conductor tracks (18) is guided further, parallel to the base plate (2) in the foot region (7) of the plastic part (5), and then, offset from the opening (14), is guided out of the foot region (7) perpendicularly.

5. Cover according to claim 1, characterized in that the foot region (7) of the plastic part (5) has a region that is embodied to be plate-like, whose upper side lies against the underside of the cover.

6. Cover according to claim 5, characterized in that electrical components (19, 20) are provided on the underside of the plate-like region of the foot region (7) of the plastic part (5), which electrical components have an electrical connection with one another and with at least one conductor track (18) that is guided out of the foot region (7).

7. Cover according to claim 6, characterized in that a flat metal grid (21) is provided on the underside of the plate-like region of the foot region (7) of the plastic part (5) for connecting the electrical components (19, 20) with one another and with the conductor tracks (18) that are guided out.

8. Cover according to claim 1, characterized in that means (13) are provided for tightly fastening the plastic part (5) on the base plate (2).

9. Cover according to claim 2, characterized in that the foot region (7) of the plastic part (5) has a region that is embodied to be plate-like, whose upper side lies against the underside of the cover.

10. Cover according to claim 3, characterized in that the foot region (7) of the plastic part (5) has a region that is embodied to be plate-like, whose upper side lies against the underside of the cover.

11. Cover according to claim 4, characterized in that the foot region (7) of the plastic part (5) has a region that is embodied to be plate-like, whose upper side lies against the underside of the cover.

12. Cover according to claim 2, characterized in that means (13) are provided for tightly fastening the plastic part (5) on the base plate (2).

13. Cover according to claim 3, characterized in that means (13) are provided for tightly fastening the plastic part (5) on the base plate (2).

14. Cover according to claim 4, characterized in that means (13) are provided for tightly fastening the plastic part (5) on the base plate (2).

15. Cover according to claim 5, characterized in that means (13) are provided for tightly fastening the plastic part (5) on the base plate (2).

16. Cover according to claim 6, characterized in that means (13) are provided for tightly fastening the plastic part (5) on the base plate (2).

17. Cover according to claim 7, characterized in that means (13) are provided for tightly fastening the plastic part (5) on the base plate (2).
